(19) United States
(12) Patent Application Publication
(10) Pub. No.: US 2021/0179310 A1
(43) Pub. Date: Jun. 17, 2021

(54) MACHINE AND METHOD FOR LABELING CONTAINERS

(71) Applicant: P.E. LABELLERS S.P.A., Porto Mantovano (IT)

(72) Inventors: Nicola SCHINELLI, Mantova (IT); Bruno NEGRI, Marmirolo (IT)

(21) Appl. No.: 17/253,678

(22) PCT Filed: Jun. 14, 2019
(86) PCT No.: PCT/EP2019/065748

§ 371 Date: Dec. 18, 2020

(30) Foreign Application Priority Data
Jun. 19, 2018 (IT) 102018000006434

(51) Int. Cl. B65C 9/22; B65C 9/18; B65C 3/06; B65C 9/02

(52) U.S. Cl. CPC B65C 9/2217; B65C 9/1807; B65C 2009/0071; B65C 9/02; B65C 3/065

(57) ABSTRACT

A machine for labeling containers conveys, along an advancement direction, the labels to be applied, which have a transfer drum which is adapted to bring individual labels into contact with corresponding containers which are supported by a conveyor. A spraying assembly faces the transfer drum and is adapted to apply glue on the labels; the spraying assembly includes at least one spray gun which has a plate-like glue dispensing body which faces the lateral surface of the transfer drum and is passed through by a plurality of dispensing ports, which are arranged mutually spaced apart along at least one row which extends substantially parallel to the axis of the transfer drum; a controller is configured to actuate a slowing of the advancement speed of the labels with respect to the spray gun before actuating the activation of the spray gun for the application of the glue on the labels.

The present invention relates to a machine and a method for labeling containers.

Labeling machines are known which make it possible to automatically carry out the application of printed labels on containers, in general, and bottles, in particular.

Typically, the labeling machines are provided with a transfer drum that makes it possible to apply, on each bottle that is progressively presented before the transfer drum, a label which is obtained by cutting a continuous ribbon of labels which is unwound from a reel.

Before being applied on the corresponding bottle, each label receives, along its leading, or front, edge and along its trailing, or rear, edge with respect to its advancement direction, a quantity of glue from a gluing assembly, which can be constituted by a gluing roller or by a spraying assembly.

Generally, in this type of labeling machine, the bottles are conveyed by a rotating carousel which is provided with a plurality of supports for the individual bottles, which are adapted to rotate the bottles about their own axis, and is provided with an unwinding roller which makes it possible to take the ribbon of labels from the reel and feed it to a cutting drum, on which, by way of cutting means, the ribbon is cut between one label and the next.

Subsequently, the individual labels, once separated after cutting, are transferred from the cutting drum to the transfer drum. In particular, the labels are arranged so that they adhere to the transfer drum at respective sectors of the outer lateral surface of the transfer drum. Such sectors are angularly mutually spaced apart about the axis of the transfer drum and are separated from each other by a separation segment.

Typically the gluing assembly is arranged so as to face the transfer drum and apply the glue at the leading and trailing edges of the individual labels placed in the sectors of the outer lateral surface of the transfer drum, before the labels are brought by that transfer drum to adhere to the corresponding bottles carried by the rotating carousel.

In particular, if the gluing assembly is constituted by a gluing roller, then at opposite ends of the various sectors of the transfer drum are two adhesive bonding regions, which are in relief with respect to the main lateral surface of the transfer drum and which are defined by respective blocks called runners, on which the leading and trailing edges of the labels come to rest, so that when the labels pass in front of the gluing drum, the latter applies only two strips of glue to those labels.

In order to prevent the labels from remaining attached to the gluing roller, they are kept adhered to the lateral surface of the transfer drum by way of holes, provided on the lateral surface of the transfer drum, which are connected to air suction means.

During the operation of the labeling machine, since individual separated labels adhere to the transfer drum, it often happens that the transfer drum can be smeared with glue, which results in the machine having to be shut down in order to carry out the necessary cleaning thereof.

If on the other hand the gluing assembly is constituted by a spraying assembly, then the latter, in order to enable the application of the glue on the labels at the high speeds with which the labels move on the transfer drum, is usually made up of a battery of several spray guns which are arranged laterally to the transfer drum.

In particular, each one of such spray guns is provided with a plurality of glue dispenser nozzles which are directed toward the outer lateral surface of the transfer drum and which, at each activation of the corresponding spray gun, are each capable of emitting a given quantity of glue which is sprayed on the labels being conveyed by the transfer drum.

In particular, the dispenser nozzles of each spray gun are arranged mutually side-by-side along a row that extends parallel to the direction of transverse extension of the labels, i.e. substantially parallel to the axis of the transfer drum, and are mutually spaced apart, along the row, by a distance that is dictated by technical requirements aimed at ensuring a valid and regular operation of the spray gun at high speeds.

In this manner, the dispenser nozzles of each spray gun apply a corresponding plurality of droplets of glue on the labels, called glue spots, which are arranged along a row that is parallel to the direction of transverse extension of the labels and which are spaced apart, from each other, by a distance that is practically equal to the distance between the dispenser nozzles.

In order to be capable of applying a row of droplets of glue on the labels with a distance between two consecutive droplets along the row that is smaller than the distance between the dispenser nozzles of the spray guns, the spray guns are arranged side by side, one after the other, along a direction parallel to the advancement direction of the labels and are arranged differently beside each other along a direction parallel to the axis of the transfer drum, so that the dispenser nozzles of each spray gun are arranged offset with respect to those of the other spray guns.

The spray guns, thus arranged, are activated sequentially one after the other so that the droplets of glue applied by the spray guns after the first spray gun encountered by the label come to be positioned in an interleaved position between the droplets applied by each preceding spray gun.

In order to enable the spray guns to dispense the glue one after the other very quickly, given the high speed of the labels conveyed by the transfer drum, they must work at relatively high levels of pressure of the glue, with consequent considerable production of glue vapors and risk of unwanted smearing of the components of the machine.

The aim of the present invention is to provide a machine for labeling containers which is capable of improving the known art in one or more of the above mentioned aspects.

Within this aim, an object of the present invention is to provide a machine for labeling containers that makes it possible to prevent unwanted smearing of the transfer drum or other components of the machine with glue.

Another object of the present invention is to provide a machine for labeling containers that constitutes a considerable simplification in terms of construction and operation compared to traditional machines of this type which are fitted with a glue spraying assembly.

Another object of the present invention is to provide a machine for labeling containers that can operate positively using only one spray gun.

Another object of the present invention is to provide a machine for labeling containers that is capable of offering the widest guarantees of reliability and safety in its operation.

Another object of the present invention is to provide a method for labeling containers that makes it possible to execute an optimal application of glue on the labels.

Another object of the present invention is to provide a machine for labeling containers that is of low cost, so as to be competitive from a purely economic viewpoint as well.

This aim and these and other objects which will become better apparent hereinafter are achieved by a machine for labeling containers, according to the invention, as defined in claim 1.

Further characteristics and advantages of the present invention will become better apparent from the description of a preferred, but not exclusive, embodiment of the machine according to the invention, which is illustrated by way of non-limiting example in the accompanying drawings wherein:

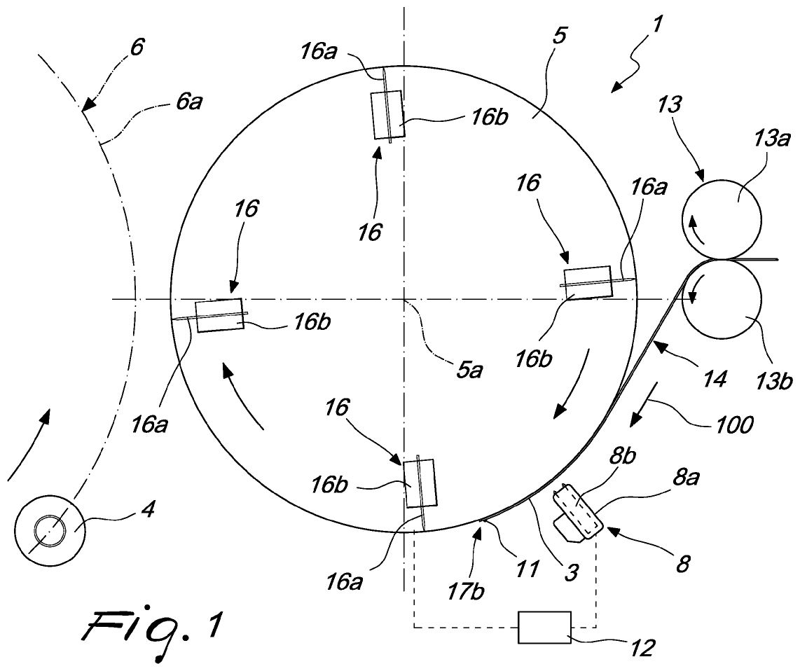

FIG. 1 is a schematic plan view from above the machine according to the invention;

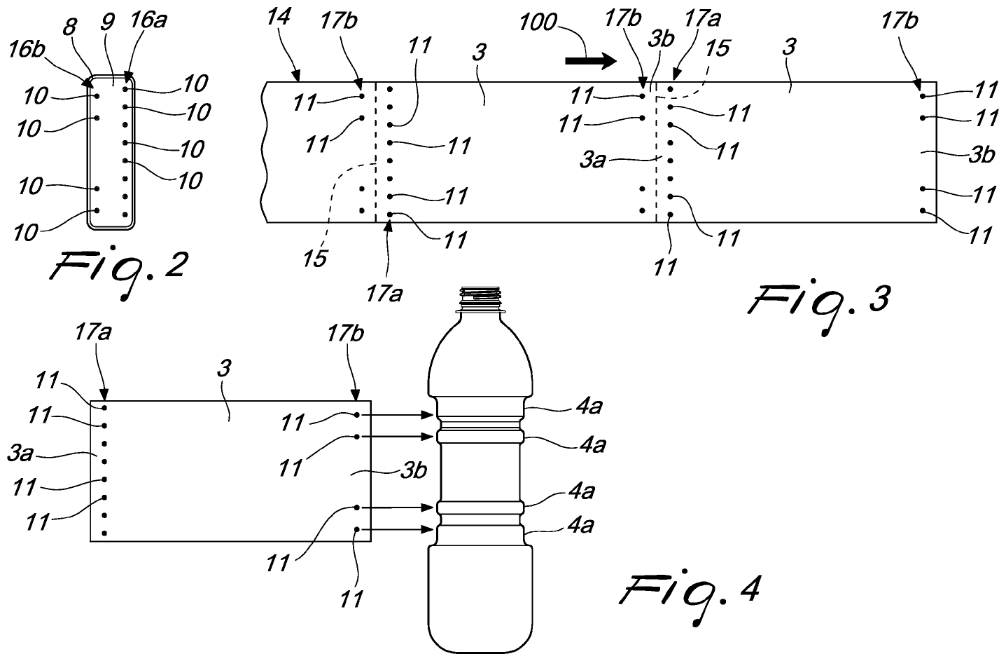

FIG. 2 is a front elevation view of a spray gun of the machine according to the invention;

FIG. 3 is a front elevation view of a labeling ribbon highlighting the glue spots, at the leading end and at the trailing end of the various labels, that can be applied by the spray gun of the machine according to the invention;

FIG. 4 is a side view of a label with glue spots that can be applied by the spray gun of the machine according to the invention and a corresponding container, to highlight the correspondence between the position of glue spots placed proximate to the leading edge of the label with raised portions that are present on the container;

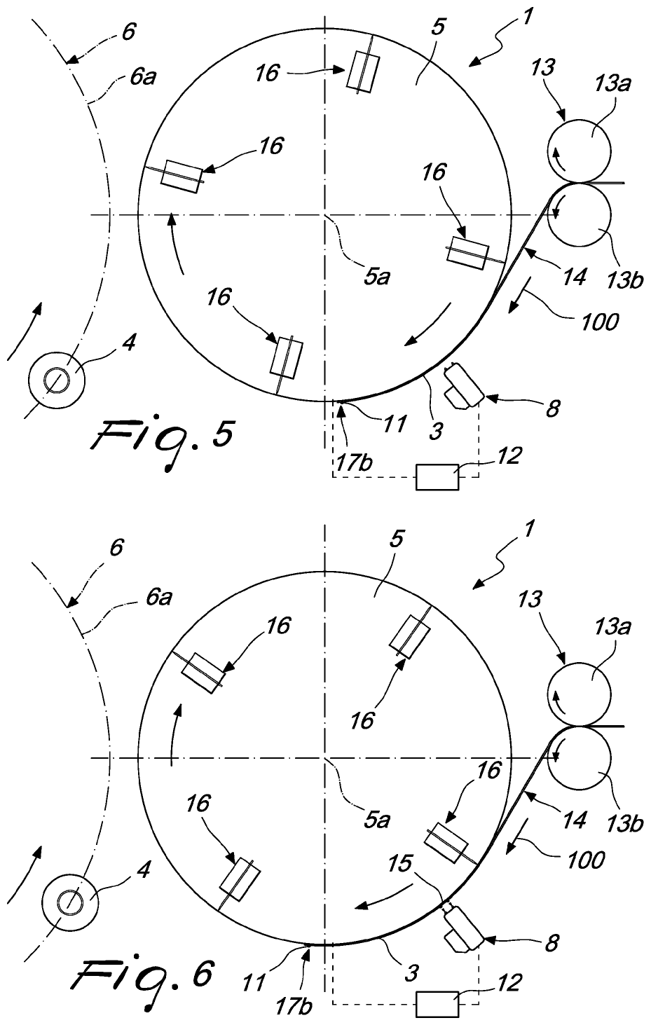

FIGS. 5 to 10 are schematic plan views from above of a sequence of steps of operation of the machine according to the invention;

FIG. 11 is a schematic plan view from above of the machine according to the invention with a possible variation of embodiment of the cutting means.

With reference to the figures, the machine for labeling containers, according to the invention, generally designated with the reference numeral 1, comprises conveyor means 2 that make it possible to move one or more labels 3 to be applied on the containers 4 to be labeled according to a advancement direction 100.

Such conveyor means 2 comprise a transfer drum 5 which is actuated in rotation about its own axis 5a and which makes it possible to bring the individual labels 3 into contact with corresponding containers 4, which are supported by a conveyor 6 which moves the containers 4 in an advancement direction along a trajectory 6a, for example substantially shaped like a circular arc, and which is, preferably, constituted, as is normal, by a rotating carousel which is provided with a plurality of supports which are designed to receive a respective container 4 resting thereon and to rotate it about its own axis.

A spraying assembly 7 faces the transfer drum 5 and is intended to apply glue on the labels 3, in order to allow the subsequent adhesion of the latter to the corresponding containers 4.

According to the invention, the spraying assembly 7 comprises at least one spray gun 8 which has a plate-like glue dispensing body 9 which faces the lateral surface of the transfer drum 5 and is passed through by a plurality of dispensing ports 10, which are adapted to connect the inside of the spray gun 8 with the outside.

The dispensing ports 10 are, in particular, arranged mutually spaced apart along at least one row which extends substantially parallel to the axis 5a of the transfer drum 5, in order to enable the application on the labels 3 of at least one line of glue spots 11 which extends transversely to the advancement direction of the labels 3.

Control means 12 are further provided, which conveniently comprise an electronic controller and are functionally connected to the conveyor means 2 and to the spray gun 8 and the function of which is to actuate a slowing of the advancement speed of the labels 3, with respect to the spray gun 8, before actuating the activation of the spray gun 8 for executing the application of the glue on the labels 3.

It should be noted that, according to a preferred embodiment, the spraying assembly 7 can be provided with only a single spray gun 8.

With reference to the embodiment shown in FIG. 1, the conveyor means 2 comprise, upstream of the transfer drum 5, an unwinding assembly 13 that feeds the transfer drum 5 with a labeling ribbon 14 on which a plurality of labels 3 are printed continuously along its extension, by making it advance along the advancement direction 100.

Conveniently, the unwinding assembly 13 comprises two feeding rollers 13a and 13b, which engage the labeling ribbon 13 on mutually opposite sides and are rotated in mutually opposite directions in order to entrain the labeling ribbon 14 in the direction of the transfer drum 5.

Advantageously, in order to allow to the transfer drum 5 to receive the labeling ribbon 13 by making it adhere to its lateral surface, the transfer drum 5 is provided, on its lateral surface, with a plurality of suction holes, which are connected to air suction means.

In particular, the transfer drum 5 is further rotationally actuated at a constant speed, which is synchronized with the speed of the conveyor 6, so as to be in phase with it and be able therefore to deliver a label to a corresponding container 4 arriving on the conveyor 6.

Conveniently, the transfer drum 5 is provided with means for cutting the labeling ribbon 13, which are arranged on its lateral surface and can be activated on command by activation means, in order to carry out the cutting of the labeling ribbon 13 at the connecting region 15 between two consecutive labels 3 that are present along the labeling ribbon 14.

In particular, the control means 12 activate the spray gun 8 so as to apply the glue on at least one of the labels 3 that are present along the labeling ribbon 14, before the cutting means are activated by the corresponding activation means, for the purpose of carrying out the separation of the label or labels 3, on which the spray gun 8 has applied the glue, from the labeling ribbon 14.

Preferably, the means for cutting the labeling ribbon 13 are constituted by a plurality of cutting devices 16, which are mutually angularly spaced apart about the axis 5a of the transfer drum 5 and can be activated on command, independently, in order to carry out the cutting of the labeling ribbon 14, so as to separate a label 3 from it in each instance.

For example, the cutting devices 16 can each be provided by a respective cutting knife 16a, which is supported by the transfer drum 5 and can be actuated to move, in order to carry out the cutting of the labeling ribbon 14, by a respective working cylinder 16b, which is also fitted on the transfer drum 5 and, advantageously, is functionally connected to the control means 12.

According to a possible alternative embodiment, shown in FIG. 11, each cutting device 16 is provided with a respective blade 16c, which is integral with the transfer drum 5 and accommodated in a respective chamber 16d, which is defined in the transfer drum 5 and open at the lateral surface thereof. The chamber 16d of each cutting device 16 is connected to air extraction means, which, once activated and connected to the chamber 16d, make it possible to attract, inward into the chamber 16d, the segment of the portion of the labeling ribbon 14 resting on the lateral surface of the transfer drum 5 which is in front of the chamber 16d, so as to bring such segment into contact with the blade 16c and as a consequence cut it.

With reference to FIG. 2, in an embodiment, in the plate-like dispensing body 9 of the spray gun 8 there are, conveniently, at least two rows 16a and 16b of glue dispensing ports 10 and, more specifically, at least one first row 16a and at least one second row 16b, which are mutually parallel and are spaced apart, from each other, along a direction that is substantially parallel to the advancement direction 100 of the labels 3.

In practice, the first row 16a of dispensing ports 10 is arranged downstream of the second row 16b according to the advancement direction 100 of the labeling ribbon 14 on the transfer drum 5.

In particular, the two rows 16a and 16b of dispensing ports 10 are intended to apply respective lines 17a and 17b of glue spots 11 on the labels 3.

Advantageously, the control means 12 are adapted to actuate the activation of the spray gun 8 in order to enable the application of such lines 17a and 17b of glue spots 11 by the rows 16a and 16b of dispensing ports 10 on two consecutive labels 3 which are present along the labeling ribbon 13, before these two consecutive labels 3 are separated from the labeling ribbon 14 by way of cutting it.

In detail, the lines 17a and 17b of glue spots 11 are, conveniently, applied, respectively, proximate to the trailing edge 3a of one of the two consecutive labels 3, in particular the one that is in front of the other with respect to the advancement direction 100 of the labeling ribbon 14, and proximate to the leading edge 3b of the other of the two consecutive labels 3.

More precisely, the line 17a of glue spots 11 is applied by the first row 16a of dispensing ports 10 proximate to the trailing edge 3a of the label 3 that, of the two consecutive labels 3, is in front of the other, with respect to the advancement direction 100 of the labeling ribbon 14, while the line 17b of glue spots 11 is applied by the second row 16b of dispensing ports 10 proximate to the leading edge 3b of the other of the two consecutive labels 3 i.e. the one behind.

Conveniently, the control means 12 are adapted to drive the unwinding assembly 13 in order to vary the speed with which the labeling ribbon 14 is fed to the transfer drum 5 by the unwinding assembly 13, during the rotation of the transfer drum.

In particular, the control means 12 are capable of controlling the unwinding assembly 13 so as to be able to vary the speed of feeding the labeling ribbon 14 to the transfer drum 5 between at least two speeds, respectively a first speed, which is synchronized with respect to the speed of the transfer drum 5, so that the labeling ribbon 14 is entrained by the transfer drum 5 without sliding, and at least one second speed, which is lower than the first speed and, preferably, nil i.e. equal to zero.

More specifically, the control means 12 actuate a slowing of the speed of feeding the labeling ribbon 14 to the transfer drum 5, in order to take it from the first speed to the second speed, at least at the arrival, at the spray gun 8, of the trailing edge 3a and of the leading edge 3b of two consecutive labels 3.

Once such slowing of the speed of feeding the labeling ribbon 14 has been actuated, the control means 12 actuate the activation of the spray gun 8, in order to apply, proximate to the trailing edge 3a and proximate to the leading edge 3b of the two consecutive labels 3 which have arrived at said spray gun 8, respective lines 17a and 17b of glue spots 11 and, subsequently, they actuate the increase of the speed of feeding of the labeling ribbon 14, in order to return it to the value preceding the slowing, i.e. to the first speed.

Conveniently, such increase of the speed of feeding the labeling ribbon is actuated by the control means 12 after they actuated the activation of the cutting means in order to carry out the cutting of the labeling ribbon 14 at the connecting region 15 between the two consecutive labels 3 on which the spray gun 8 has applied the glue.

More preferably, upon arrival, at the spray gun 8, of the trailing edge 3b and of the leading edge 3a of two consecutive labels 3 that are present on the labeling ribbon 14, the control means 12 actuate the stop of the unwinding assembly 13 with consequent stop also of the advancement of the labeling ribbon 14 with respect to the spray gun 8, which can thus apply the lines 17a, 17b of glue spots 11 on the two consecutive labels 3 with the labeling ribbon 14 stationary.

During the stop or, in any case, the slowing of the advancement of the labeling ribbon 14, the transfer drum 5, continuing to rotate about its own axis 5a at the same speed, swipes on the labeling ribbon 14, thus enabling one of the cutting devices 16 to be brought to the connecting region 15 between the two consecutive labels 3 on which the spray gun 8 has applied the lines 17a and 17b of glue spots 11. Once one of the cutting devices 16 reaches the connecting region 15 between the two consecutive labels 3 on which the spray gun 8 has applied glue, or before this point, the control means 12 will actuate the increase of the speed of feeding the labeling ribbon 14 to the transfer drum 5 by the unwinding assembly 13, so that the labeling ribbon 14 can restore its advancement to the first speed in the advancement direction 100, and they will then actuate the cutting device 16 which in the meantime will have reached the connection region 15 between the two consecutive labels 3, so that such cutting device 16 cuts the labeling ribbon 14 between the two consecutive labels 3, separating them from each other.

As a consequence, the label 3 that, of the two consecutive labels 3, is in front of the other, with respect to the advancement direction 100, no longer being connected to the labeling ribbon 14, can be entrained by the transfer drum 5 toward the corresponding container 4.

Delving deeper into the details of the spray gun 8, the dispensing ports 10 each comprise a respective spray nozzle that makes it possible to create a glue spot 11 of uniform dimensions on the labels 3.

Conveniently, the spray gun 8 is provided by a main body 8a which defines at least one glue accumulation chamber 8b, which is supplied with glue at low pressure and is closed on the side that is directed toward the transfer drum 5 by the plate-like body 9.

It should be noted that the dispensing ports 10 can optionally be arranged along the respective row 16a or 16b at mutually irregular distances.

In particular, conveniently, the distance between at least two dispensing ports 10 of one row 16a, 16b can be different from the distance between other dispensing ports 10 of the same row 16a, 16b.

It is also possible for the dispensing ports 10 of one row 16a, 16b to be distributed along the corresponding row 16a, 16b differently from the dispensing ports 10 of the other row 16a, 16b.

More specifically, for example, the distance between the dispensing ports 10 of one row 16a, 16b can be different from the distance between the dispensing ports of the other row 16a, 16b.

It should be noted that, according to a possible embodiment, the dispensing ports 10 at least of the second row 16, i.e. of the row intended to apply the line 17b of glue spots 11 proximate to the leading edge 3b of the labels 3, can, for example, be arranged so that the corresponding glue spots 11 are located at corresponding raised portions 4a which are present on the lateral surface of the containers 4, as shown schematically in FIG. 4. This offers the possibility of ensuring a perfect adhesion of the labels 3 even on containers 4 that have a variously contoured lateral surface.

Operation of the machine according to the invention is the following.

In a first step of operation, the unwinding assembly 3 feeds the labeling ribbon 14 to the transfer drum 5 at a first speed which substantially corresponds to the peripheral speed of the transfer drum 5, so that the labeling ribbon 14 and the transfer drum 5 are synchronized with each other.

With reference to FIG. 5, when the trailing edge 3a and the leading edge 3b of two consecutive labels 3 approach or in any case are positioned at the spray gun 8, the control means 12 actuate the unwinding assembly 13 to slow the advancement speed of the labeling ribbon 14 down to a second speed, lower than the first speed, and more preferably until it stops. It should be noted that, in this situation, the transfer drum 5, which continues rotating at the same speed, will begin to swipe on the labeling ribbon 14.

At this point, as shown in FIG. 6, the control means 12 activate the spray gun 8, so that the first row 16a of dispensing ports 10 applies a line 17a of glue spots 11 proximate to the trailing edge 3a of the label 3 that is in front, with respect to the advancement direction 100 of the labeling ribbon 14, and the second row 16b of dispensing ports 10 applies a line 17b of glue spots 11 proximate to the leading edge 3b of the following label 3.

In the meantime, the swiping of the transfer drum 5 on the labeling ribbon 14 which occurs as a result of reducing the advancement speed of the labeling ribbon 14 enables one of the cutting devices 16 on the transfer drum 5 to be brought toward the connecting region 15 between the two consecutive labels 3 which have received, respectively, the lines 17a and 17b of glue spots 11.

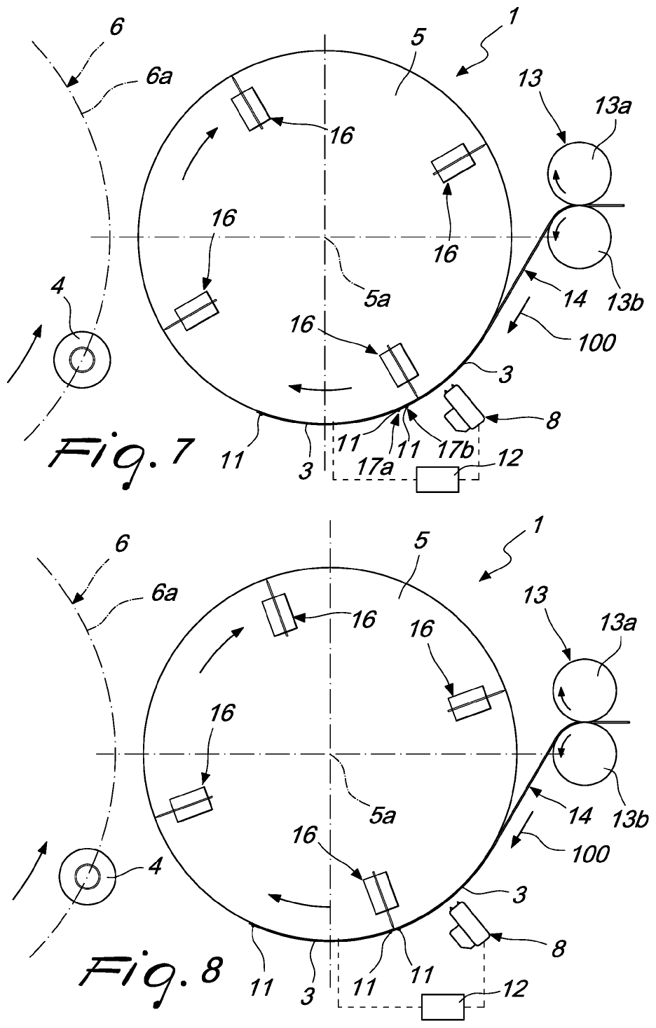

At this point, the control means 12 actuate the unwinding assembly 13 in order to obtain the increase of the speed of the labeling ribbon 14, so that it can be progressively brought from the second speed up to the first speed. The increase in the speed of the labeling ribbon 14 by the unwinding assembly 13 occurs in such a way that, while the labeling ribbon 14 moves at a speed comprised between the second speed and the first speed, one of the cutting devices 14 will continue to progressively approach the connecting region 15 of the two consecutive labels 3 that have received the glue, as shown in FIG. 7, and, once said cutting device 14 has reached the connecting region 15 of the two consecutive labels 3 that have received the glue, the labeling ribbon 14 will in turn have again reached the first speed so as to move synchronously with the transfer drum 5 and, therefore, also with the cutting device 14 that has reached the connecting region 15 of the two consecutive labels 3 that have received the glue, as shown in FIG. 8.

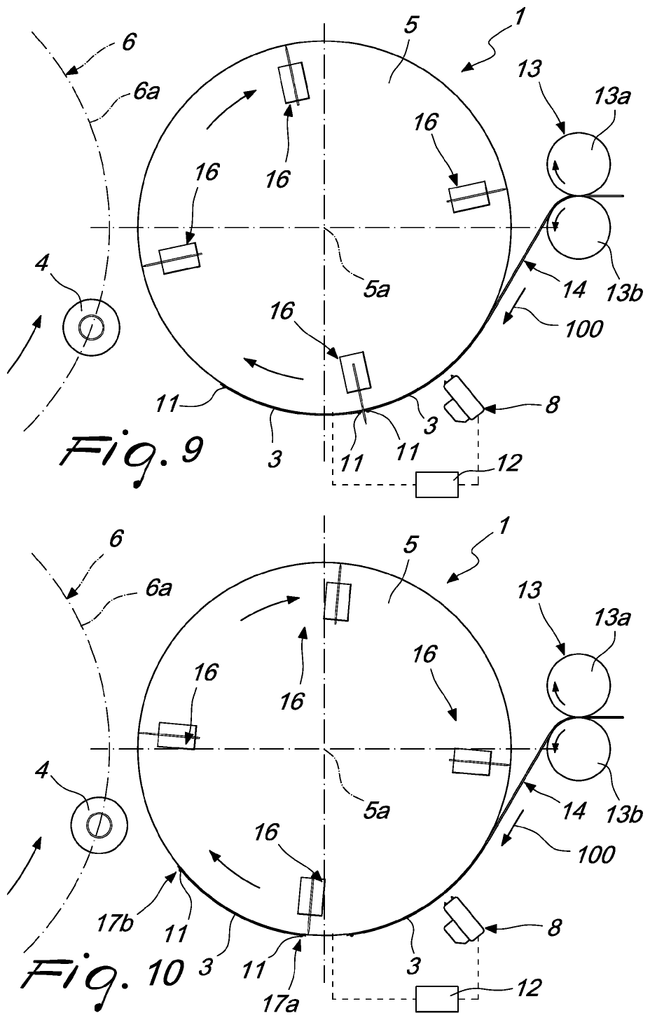

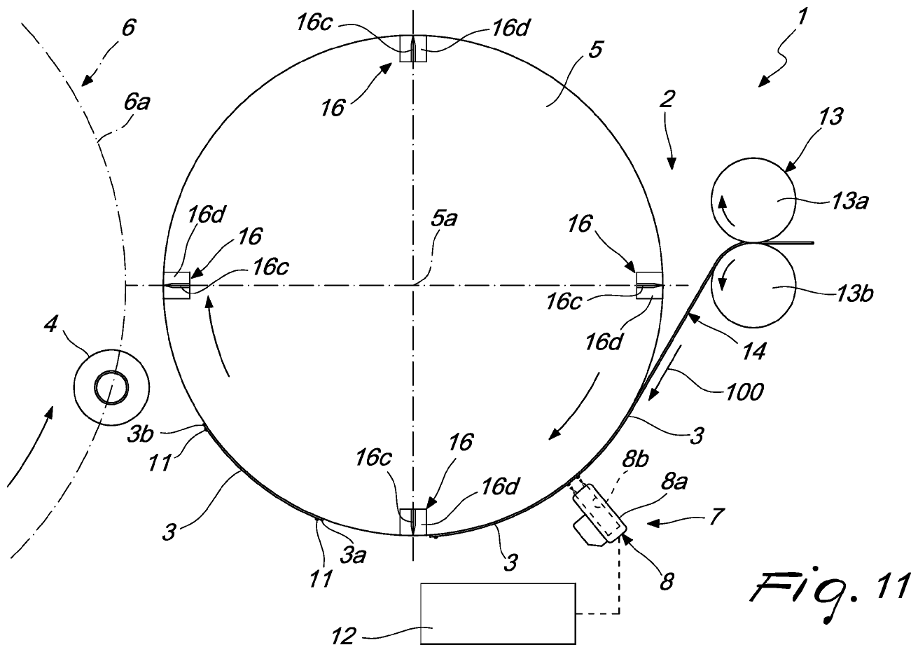

Subsequently, as shown in FIG. 9, the cutting device 16 that has reached the connecting region 15 between the two consecutive labels 3 that have received the glue is activated, so as to carry out the separation from the labeling ribbon 14 of the front label 3, which, since it is no longer attached to the labeling ribbon 14, is entrained by the transfer drum 5, which, continuing its rotation, will bring the cut label 3 to the region of tangency between the transfer drum 5 and the conveyor 6, where the adhesion of the cut label 3 to the corresponding container 4 takes place, as shown in FIG. 10.

At this point, operation resumes as described above.

From the foregoing it can be seen that the invention is capable of fully achieving the set aim and objects.

All the characteristics of the invention, indicated above as advantageous, convenient or similar, may also be missing or be substituted by equivalent characteristics.

The individual characteristics set out in reference to general teachings or to specific embodiments may all be present in other embodiments or may substitute characteristics in such embodiments.

The invention, thus conceived, is susceptible of numerous modifications and variations, all of which are within the scope of the appended claims.

In practice the materials employed, provided they are compatible with the specific use, and the dimensions and shapes, may be any according to requirements.

Moreover, all the details may be substituted by other, technically equivalent elements.

The disclosures in Italian Patent Application No. 102018000006434 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-15. (canceled)

16. A machine for labeling containers, which comprises conveyor means for conveying, along an advancement direction, the labels to be applied, said conveyor means being provided with a transfer drum which is adapted to bring individual labels into contact with corresponding containers which are supported by a conveyor, a spraying assembly facing said transfer drum and being adapted to apply glue on the labels, wherein said spraying assembly comprises at least one spray gun which has a plate-like glue dispensing body which faces a lateral surface of said transfer drum and is passed through by a plurality of dispensing ports, which are configured to connect an inside of said spray gun to an outside and are mutually spaced apart along at least one row which extends substantially parallel to an axis of said transfer drum, in order to enable the application on the labels of at least one line of glue spots which extends transversely to the advancement direction of the labels, control means being provided which are functionally connected to said conveyor means and to said spray gun and being configured to actuate a slowing of an advancement speed of the labels with respect to said spray gun before an activation of said spray gun for the application of the glue on the labels.

17. The machine according to claim 16, wherein said conveyor means comprise an unwinding assembly feeding said transfer drum with a labeling ribbon on which a plurality of labels are printed continuously along an extension thereof, said transfer drum being provided with cutting means, which are distributed around its lateral surface and can be activated on command by activation means in order to cut said labeling ribbon at a connecting region between two consecutive labels which are present on said labeling ribbon, said control means being configured to activate said spray gun in order to apply glue on at least one of the labels before said activation means activate said cutting means in order to separate, from said labeling ribbon, said at least one label on which said spray gun has applied the glue.

18. The machine according to claim 16, wherein at least two rows of glue dispensing ports are defined in said plate-like dispensing body, are mutually parallel and are mutually spaced apart along a direction that is substantially parallel to the advancement direction of the labels, said at least two rows of dispensing ports each being adapted to apply a respective line of glue spots on the labels, said control means being adapted to actuate said spray gun in order to apply said lines of glue spots on two consecutive labels which are present on said labeling ribbon, respectively proximate to a trailing edge of one and proximate to a leading edge of another of said two consecutive labels, prior to their separation from said labeling ribbon.

19. The machine according to claim 16, wherein said spray gun comprises a main body which defines at least one glue accumulation chamber, said accumulation chamber being closed on a side that is directed toward said transfer drum by said plate-like body.

20. The machine according to claim 16, wherein the dispensing ports are arranged along the respective row at mutually irregular distances.

21. The machine according to claim 16, wherein the dispensing ports of one row are distributed along the corresponding row differently from the dispensing ports of the other row.

22. The machine according to claim 16, a distance between at least two dispensing ports of one row is different from a distance between other dispensing ports of the same row.

23. The machine according to claim 16, wherein a distance between the dispensing ports of one row is different from a distance between the dispensing ports of the other row.

24. The machine according to claim 16, wherein the dispensing ports at least of the row intended to apply the line of glue spots proximate to the leading edge of the labels are arranged so that the corresponding glue spots are located at raised portions which are present on the lateral surface of the containers.

25. The machine according to claim 16, wherein said control means are adapted to drive said unwinding assembly in order to vary the speed at which said labeling ribbon is fed to said transfer drum by said unwinding assembly, during the rotation of said transfer drum.

26. The machine according to claim 16, wherein said control means are adapted to actuate, in sequence: a slowing of the speed at which said supply ribbon is fed to said transfer drum, at least upon the arrival, at said spray gun, of the trailing edge and of the leading edge of two consecutive labels; the activation of said spray gun in order to apply, proximate to the trailing edge and proximate to the leading edge of the two consecutive labels which have arrived at said spray gun, respective lines of glue spots; and an increase of the speed of feeding said feeding ribbon to a speed value preceding said slowing.

27. A method for labeling containers, which comprises the steps of:
conveying at least one label by way of a transfer drum at a first advancement speed,
substantially upon arrival or prior to the arrival of at least one portion of said at least one label substantially at a spray gun which faces said transfer drum, slowing the first advancement speed of said at least one label in order to bring it to a second advancement speed which is lower than said first advancement speed,
applying at least one line of glue spots to said at least one label by way of said spray gun,
increasing the advancement speed of said at least one label until said advanced speed returns to said first advancement speed,
bringing, by way of said transfer drum, said at least one label with the glue applied into contact with a corresponding container.

28. The method according to claim 27, further comprising the steps of:
feeding, at said first advancement speed, by way of an unwinding assembly, said transfer drum with at least one portion of a labeling ribbon on which a plurality of labels are printed continuously along its extension,
slowing the first advancement speed at which the labeling ribbon is fed to the transfer drum down to said second advancement speed when the trailing edge and the leading edge of two consecutive labels which are present on the labeling ribbon reach said spray gun,
activating said spray gun in order to apply a respective line of glue spots on the trailing edge and on the leading edge of said consecutive labels,
increasing the speed at which said labeling ribbon is fed to said transfer drum up until said first speed.

29. The method according to claim 28, further comprising, after the step of activating said spray gun, the steps of:
cutting, by way of cutting means, said labeling ribbon at the connecting region between said consecutive labels on which the glue has been applied,
conveying, by way of said transfer drum, the labels, separated after cutting, into contact with corresponding containers supported by a conveyor.

30. The method according to claim 29, wherein it entails:
after the application of said lines of glue spots on the trailing edge and on the leading edge of said consecutive labels, feeding said labeling ribbon to said transfer drum at a speed that is substantially comprised between said first advancement speed and said second advancement speed, in order to allow a cutting device which is associated with said transfer drum to reach a connecting region between said consecutive labels, and
with said cutting device at the connecting region between said consecutive labels, activating said cutting device in order to cut said labeling ribbon at the connecting region between said consecutive labels.
